(19) United States
(12) Patent Application Publication
(10) Pub. No.: US 2024/0347820 A1
(43) Pub. Date: Oct. 17, 2024

(54) BATTERY AND ELECTRONIC DEVICE CONTAINING SAME

(71) Applicant: Dongguan Amperex Technology Limited, Dongguan (CN)

(72) Inventors: Yong LI, Dongguan (CN); Liangzhen XIAO, Dongguan (CN); Qiao ZENG, Dongguan (CN)

(73) Assignee: Dongguan Amperex Technology Limited, Dongguan (CN)

(21) Appl. No.: 18/754,859

(22) Filed: Jun. 26, 2024

Related U.S. Application Data
(63) Continuation of application No. PCT/CN2021/141633, filed on Dec. 27, 2021.

(51) Int. Cl. H01M 50/124; H01M 4/36; H01M 10/04; H01M 50/11; H01M 50/119; H01M 50/121; H01M 50/538

(52) U.S. Cl. CPC H01M 50/124; H01M 4/366; H01M 10/0431; H01M 50/11; H01M 50/119; H01M 50/121; H01M 50/538

(57) ABSTRACT

A battery including electrode plates and a housing accommodating the electrode plates. The electrode plates include a negative electrode plate located on an outermost layer. The negative electrode plate includes a first edge extending along a first direction and a second edge extending along a second direction, and the first direction is perpendicular to the second direction. The first edge is connected to the second edge by a third edge. The first edge intersects the third edge to form a first intersection point. The housing includes a first wall, a second wall, and a third wall that are connected to each other. The first wall is connected to the second wall by a first arc wall. The first wall is connected to the third wall by a second arc wall. The second wall is connected to the third wall by a third arc wall.

### CROSS-REFERENCE TO RELATED APPLICATION

This application is a continuation application of PCT international application No. PCT/CN2021/141633, filed on Dec. 27, 2021, the content of which is incorporated herein by reference in its entirety.

### TECHNICAL FIELD

This application relates to the field of energy storage devices, and in particular, to a battery and an electronic device containing the battery.

### BACKGROUND

Lithium-ion batteries are widely used in the field of consumer electronics by virtue of many advantages such as a high energy density, a long cycle life, a high nominal voltage, a low self-discharge rate, a small size, and a light weight. With the rapid development of electric vehicles and mobile electronic devices in recent years, people are imposing higher requirements on an energy density, a lifespan, manufacturing efficiency, and the like of batteries. Therefore, the structure of a battery needs to be continuously optimized.

### SUMMARY

An objective of this application is to disclose a battery to increase the lifespan of a housing of the battery.

A first aspect of this application provides a battery. The battery includes an electrode assembly and a housing accommodating the electrode assembly. The electrode assembly includes electrode plates and a first layer containing an insulation material. The electrode plates include a positive electrode plate and a negative electrode plate. The first layer is disposed between the positive electrode plate and the negative electrode plate. The negative electrode plate is located on an outermost layer of the electrode plates. The negative electrode plate includes a first edge extending along a first direction and a second edge extending along a second direction. The first direction is perpendicular to the second direction. The first edge is connected to the second edge by a third edge. The first edge intersects the third edge to form a first intersection point. The housing includes a first metal layer and a second layer containing a polymer material, and the first metal layer and the second layer are stacked together. The second layer is disposed closer to the electrode assembly than the first metal layer. The housing further includes a first wall, a second wall, and a third wall that are connected to each other. The first wall is connected to the second wall by a first arc wall. The first wall is connected to the third wall by a second arc wall. The second wall is connected to the third wall by a third arc wall. An arc radius of the first arc wall is R₁. An arc radius of the second arc wall is R₂. A midpoint connection line of the first arc wall, a midpoint connection line of the second arc wall, and a midpoint connection line of the third arc wall intersect to form a second intersection point. The electrode assembly further includes a first surface and a second surface disposed opposite to each other in a third direction. The third direction is perpendicular to the first direction and the second direction. The negative electrode plate includes a part containing the first intersection point, and an orthogonal projection of the second intersection point on the first surface or the second surface of the electrode assembly on which the part is located is a third intersection point. A distance L between the third intersection point and the first intersection point satisfies L≥0.8(R₁+R₂).

This application forms a notch structure by disposing a third edge at a corner position of the ending end of the negative electrode plate. In this way, the angle located at the ending end of the negative electrode plate is far away from the corner position of the housing. In addition, the orthogonal projection of a spherical face center at the corner position of the housing on the first surface or the second surface of the electrode assembly on which the ending end of the negative electrode plate is located forms a third intersection point O′. The third intersection point and the first intersection point A located at the corner of the ending end of the negative electrode plate satisfy the relational expression L≥0.8(R₁+R₂), thereby reducing the risk of the negative electrode plate piercing the second layer of the housing, and in turn, reducing the risk of contact between the first metal layer of the housing and the negative electrode plate or an electrolyte solution, alleviating corrosion, and increasing the lifespan of the housing.

According to some embodiments of this application, both a junction between the third edge and the first edge and a junction between the third edge and the second edge are arc-shaped transition connections.

According to some embodiments of this application, an angle formed at a junction between the third edge and the first edge is an obtuse angle or an acute angle, and an angle formed at a junction between the third edge and the second edge is an obtuse angle or an acute angle.

According to some embodiments of this application, one of a junction between the third edge and the first edge or a junction between the third edge and the second edge is an arc-shaped transition connection, and an angle formed at the other one of the junctions is an obtuse angle or an acute angle.

According to some embodiments of this application, the third edge includes at least one of a curve or a straight line.

According to some embodiments of this application, the negative electrode plate, the first layer, and the positive electrode plate are stacked and then wound to form the electrode assembly. The electrode assembly further includes a first straight portion and a second straight portion that are disposed opposite to each other in the third direction as well as a first bend portion and a second bend portion. The first bend portion and the second bend portion are connected between the first straight portion and the second straight portion and disposed opposite to each other in the first direction.

According to some embodiments of this application, an ending end of the negative electrode plate is located in the first bend portion. In this way, the angle located at the corner position of the ending end of the negative electrode plate can be far away from the corner position of the housing, thereby reducing the risk that the negative electrode plate pierces the second layer of the housing.

According to some embodiments of this application, an ending end of the positive electrode plate is located in the first bend portion.

According to some embodiments of this application, an ending end of the first layer is located in the first bend portion.

According to some embodiments of this application, the first intersection point is located in the first straight portion.

According to some embodiments of this application, the first layer is located on an outermost layer of the electrode assembly. The electrode assembly further includes a third layer containing an insulation material, and the third layer is connected to the first layer and located in the first bend portion. By disposing the third layer, the electrode assembly can be firmly connected to the housing.

According to some embodiments of this application, a surface of the first layer is covered with a coating. By applying the coating, the safety performance and mechanical performance of the first layer can be improved, and corrosion is alleviated.

According to some embodiments of this application, the negative electrode plate includes a second metal layer, a first conductive material layer, and a second conductive material layer. The second metal layer includes a first face and a second face that are disposed opposite to each other. The negative electrode plate further includes a starting end and an ending end that are disposed opposite to each other in a winding direction of the electrode assembly. The first conductive material layer is disposed continuously on the first face from the starting end of the negative electrode plate to the ending end of the negative electrode plate. The second conductive material layer is disposed continuously on the second face from the starting end of the negative electrode plate to the ending end of the negative electrode plate.

According to some embodiments of this application, the negative electrode plate further includes a plurality of negative tabs formed by extending the electrode plate from one side of the second metal layer.

According to some embodiments of this application, the negative electrode plate further includes a first current collecting plate. The plurality of negative tabs are bent in the housing to form a first tab group. The first tab group is connected to the first current collecting plate. An end, away from the first tab group, of the first current collecting plate, protrudes out of the housing.

According to some embodiments of this application, the positive electrode plate includes a third metal layer, a third conductive material layer, and a fourth conductive material layer. The third metal layer includes a third face and a fourth face that are disposed opposite to each other. The positive electrode plate further includes a starting end and an ending end that are disposed opposite to each other in a winding direction of the electrode assembly. The third conductive material layer is disposed continuously on the third face from the starting end of the positive electrode plate to the ending end of the positive electrode plate. The fourth conductive material layer is disposed continuously on the fourth face from the starting end of the positive electrode plate to the ending end of the positive electrode plate.

According to some embodiments of this application, the positive electrode plate includes a plurality of positive tabs formed by extending the electrode plate from one side of the third metal layer.

According to some embodiments of this application, the positive electrode plate further includes a second current collecting plate. The plurality of positive tabs are bent in the housing to form a second tab group. The second tab group is connected to the second current collecting plate. An end, away from the second tab group, of the second current collecting plate, protrudes out of the housing.

According to some embodiments of this application, a thickness of the housing ranges from 80 μm to 150 μm.

According to some embodiments of this application, the first metal layer includes aluminum. The polymer material includes polyethylene, polypropylene, poly(ethylene-co-propylene), a modified polyethylene material, or a modified polypropylene material.

According to some embodiments of this application, the second metal layer includes copper.

A second aspect of this application further provides an electronic device. The electronic device includes the battery.

### BRIEF DESCRIPTION OF DRAWINGS

The above and/or additional aspects and advantages of this application will become evident and easily comprehensible through the description of some embodiments with reference with the drawings outlined below:

FIG. 1 is a schematic diagram of a battery according to an embodiment of this application;

FIG. 2 is a local cross-sectional schematic view of a housing of the battery shown in FIG. 1 sectioned along an II-II line;

FIG. 3 is a cross-sectional schematic view of an electrode assembly of the battery shown in FIG. 1;

FIG. 4 is a local top view of an A-A part of the battery shown in FIG. 1;

FIG. 5A is a schematic top view of a negative electrode plate of the electrode assembly shown in FIG. 3;

FIG. 5B is a cross-sectional schematic view of a negative electrode plate of the electrode assembly shown in FIG. 3;

FIG. 6 is a cross-sectional schematic view of the battery shown in FIG. 1 and sectioned along an IV-IV line;

FIG. 7A is a top view of a positive electrode plate of the electrode assembly shown in FIG. 3;

FIG. 7B is a cross-sectional schematic view of a positive electrode plate of the electrode assembly shown in FIG. 3;

FIG. 8 is a cross-sectional schematic view of the battery shown in FIG. 1 and sectioned along a VIII-VIII line;

FIG. 9A is a cross-sectional schematic view of an electrode assembly according to another embodiment of this application, where a sectioning direction of the cross-sectional schematic view is identical to the III-III sectioning direction in FIG. 1;

FIG. 9B is a top view of a negative electrode plate of an electrode assembly according to another embodiment of this application;

FIG. 9C is a top view of a negative electrode plate of an electrode assembly according to still another embodiment of this application;

FIG. 9D is a top view of a negative electrode plate of an electrode assembly according to still another embodiment of this application;

FIG. 10 is a local top view of a battery according to another embodiment of this application, where the position of the part shown by the local top view in the battery shown in FIG. 10 is identical to the position of the A-A part in FIG. 1;

FIG. 11 is a local top view of a battery according to still another embodiment of this application, where the position of the part shown by the local top view in the battery shown in FIG. 11 is identical to the position of the A-A part in FIG. 1;

FIG. 12A is a local top view of a battery according to still another embodiment of this application, where the position of the part shown by the local top view in the battery shown in FIG. 12A is identical to the position of the A-A part in FIG. 1;

FIG. 12B is a local top view of a battery according to still another embodiment of this application, where the position of the part shown by the local top view in the battery shown in FIG. 12B is identical to the position of the A-A part in FIG. 1;

FIG. 12C is a top view of a positive electrode plate of an electrode assembly according to another embodiment of this application;

FIG. 13 is a schematic diagram of an electronic device according to an embodiment of this application; and

FIG. 14 is a local top view of a battery according to Comparative Embodiment 1 of this application, where the position of the part shown by the local top view in the battery shown in FIG. 14 is identical to the position of the A-A part in FIG. 1.

### LIST OF REFERENCE NUMERALS

Battery 100
Electrode assembly 10
Housing 20
Second layer 21
First metal layer 22
Fourth layer 23
First layer 11
Positive electrode plate 12
Negative electrode plate 13
First surface 105
Second surface 106
First bend portion 102
Second bend portion 104
First straight portion 101
Second straight portion 103
Starting ends 11a, 12a, 13a
Ending ends 11b, 12b, 13b
First edge 13c
Second edge 13d
Third edge 13e
Fourth edge 13f
Fifth edge 13g
First wall 201
Second wall 202
Third wall 203
First arc wall 211
Second arc wall 212
Third arc wall 213
Second metal layer 131
First conductive material layer 132
Second conductive material layer 133
First face 131a
Second face 131b
Third metal layer 121
Third conductive material layer 122
Fourth conductive material layer 123
Third face 121a
Fourth face 121b
Third layer 30
Coating 40
Negative tab 134
First current collecting plate 136
First tab group 135
Positive tab 124
Second current collecting plate 126
Second tab group 125
Electronic device 200
Main body 220
First boundary 11A
Second boundary 11B
Third boundary 11C
Fourth boundary 11D
Sixth edge 12c
Seventh edge 12d
Eighth edge 12e
Ninth edge 12f
Tenth edge 12g

### DETAILED DESCRIPTION

The following describes the technical solutions in the embodiments of this application clearly and thoroughly. Evidently, the described embodiments are merely a part of but not all of the embodiments of this application. Unless otherwise defined, all technical and scientific terms used herein bear the same meanings as what is normally understood by a person skilled in the technical field of this application. The terms used in the specification of this application are merely intended to describe specific embodiments but not to limit this application.

The following describes the embodiments of this application in detail. However, this application may be embodied in many different forms, and is in no way construed as being limited to the illustrative embodiments described herein. Rather, the illustrative embodiments are provided in order to impart this application thoroughly in detail to those skilled in the art.

In addition, for brevity and clarity, the size or thickness of various components and layers in the drawings may be scaled up. Throughout the text, the same reference numerical means the same element. As used herein, the term “and/or” includes any and all combinations of one or more related items preceding and following the term. In addition, understandably, when an element A is referred to as “connecting” an element B, the element A may be directly connected to the element B, or an intermediate element C may exist through which the element A and the element B can be connected to each other indirectly.

Further, the term “may” used in describing an embodiment of this application indicates “one or more embodiments of this application”.

The technical terms used herein is intended to describe specific embodiments but not intended to limit this application. Unless otherwise expressly specified in the context, a noun used herein in the singular form includes the plural form thereof. Further, understandably, the terms “include”, “comprise”, and “contain” used herein mean existence of the feature, numerical value, step, operation, element and/or component under discussion, but do not preclude the existence or addition of one or more other features, numerical values, steps, operations, elements, components, and/or any combinations thereof.

Space-related terms, such as “on”, may be used herein for ease of describing the relationship between one element or feature and other element (elements) or feature (features) as illustrated in the drawings. Understandably, the space-related terms are intended to include different directions of a device or apparatus in use or operation in addition to the directions illustrated in the drawings. For example, if a device in the drawing is turned over, an element described as “above” or “on” another element or feature will be oriented “under” or “below” the other element or feature. Therefore, the illustrative term “on” includes both an up direction and a down direction. Understandably, although the terms such as first, second, third may be used herein to describe various elements, components, regions, layers and/or parts, such elements, components, regions, layers and/or parts are not limited by the terms. Such terms are intended to distinguish one element, component, region, layer or part from another element, component, region, layer, or part. Therefore, a first element, a first component, a first region, a first layer, or a first part mentioned below may be referred to as a second element, a second component, a second region, a second layer, or a second part, without departing from the teachings of the illustrative embodiments.

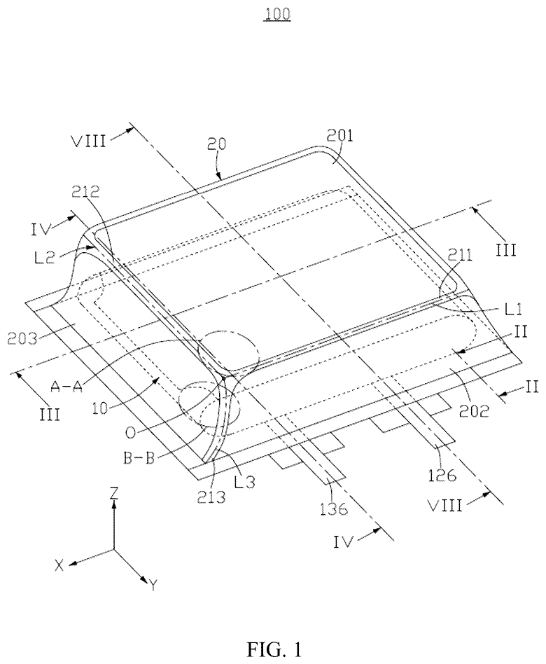

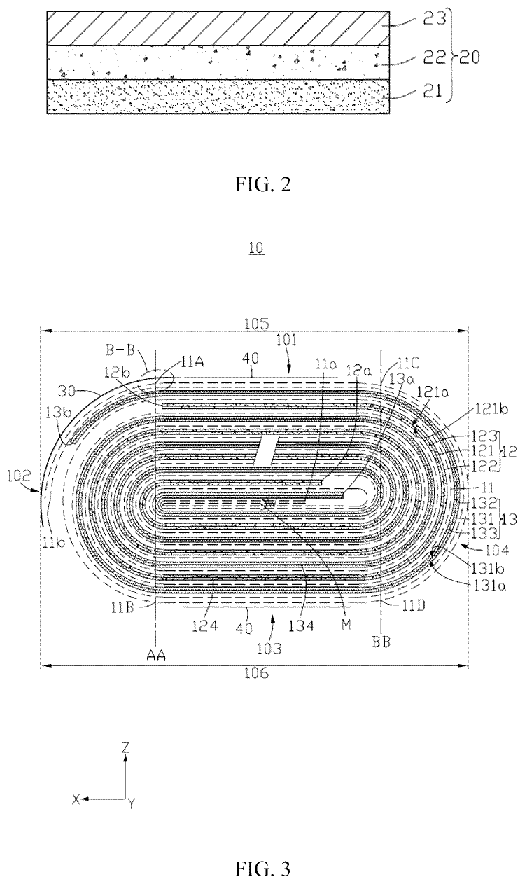

Referring to FIG. 1 and FIG. 2, an embodiment of this application provides a battery 100, including an electrode assembly 10, an electrolyte solution (not shown in the drawing), and a housing 20 accommodating the electrode assembly 10 and the electrolyte solution. A first current collecting plate 136 and a second current collecting plate 126 of the electrode assembly 10 protrude from one end of the housing 20 so as to be connected to an external component. The housing 20 may include a second layer 21, a first metal layer 22, and a fourth layer 23 that are stacked in sequence. The second layer 21 is disposed closer to the electrode assembly 10 than the first metal layer 22. The fourth layer 23 is located on the outermost side of the housing 20 and is exposed to the external environment.

The material of the second layer 21 may be any material suitable for contacting and enclosing the electrode assembly 10 in this field. In some embodiments, the second layer 21 includes a polymer material. The polymer material may be polyethylene, polypropylene, poly(ethylene-co-propylene), a modified polyethylene material, or a modified polypropylene material. The first metal layer 22 includes aluminum. The material of the first metal layer 22 may be aluminum, an aluminum-containing material of appropriate strength, or the like. The material of the fourth layer 23 may be any material suitable for contacting the external environment, and for example, may be, but is not limited to, nylon.

Referring to FIG. 3, the electrode assembly 10 includes electrode plates and a first layer 11. The electrode plates include a positive electrode plate 12 and a negative electrode plate 13. The first layer 11 is disposed between the positive electrode plate 12 and the negative electrode plate 13. The positive electrode plate 12, the first layer 11, and the negative electrode plate 13 are stacked along the third direction Z and then wound around the second direction Y to form the electrode assembly 10. A winding center of the electrode assembly 10 is M. In this application, the third direction Z means a direction perpendicular to one surface of the first current collecting plate 136 or the second current collecting plate 126, and also a stacking direction of the positive electrode plate 12, the first layer 11, and the negative electrode plate 13. The second direction Y means a direction in which the first current collecting plate 136 or the second current collecting plate 126 extends out of the housing. The second direction Y is perpendicular to the third direction Z. Viewed along the third direction Z, the electrode plate includes a plurality of alternately stacked layers of negative electrode plate 13 and layers of positive electrode plate 12. The outermost layer of the electrode plates is a layer of negative electrode plate 13, and the outer surface of the electrode plates is a surface of one layer of negative electrode plate 13. In some embodiments, viewed along the third direction Z, the first layer 11 is located at the outermost layer of the electrode assembly 10, so as to isolate the outermost layer of the electrode plates from the housing 20, where the outermost layer is a layer of negative electrode plate 13. This arrangement reduces the risk of contact between the negative electrode plate 13 and the housing 20, and protects the negative electrode plate 13 as the outermost layer of the electrode plates from being exposed to the electrolyte solution, thereby reducing the risk that the electrolyte solution corrodes the negative electrode plate 13. In some embodiments, viewed along the third direction Z, the positive electrode plate 12 may be located at the outermost layer of the electrode assembly 10. Along the second direction Y, the edge of the negative electrode plate 13 exceeds the edge of the positive electrode plate to reduce the risk of lithium plating.

The electrode assembly 10 includes a plurality of first straight portions 101 and a plurality of second straight portions 103 located on two opposite sides of the winding center M in the third direction Z, and includes a plurality of first bend portions 102 and a plurality of second bend portions 104 located on two opposite sides of the winding center M in the first direction X. Both the first straight portions 101 and the second straight portions 103 are connected to the first bend portions 102 and the second bend portions 104. In this application, the first direction X, the second direction Y, and the third direction Z are perpendicular to each other. In FIG. 3, a plurality of first straight portions 101 and a plurality of second straight portions 103 are distributed on an upper side and a lower side of the winding center M. A plurality of first bend portions 102 and a plurality of second bend portions 104 are distributed on the left side and the right side of the winding center M. The electrode assembly 10 further includes a first surface 105 and a second surface 106 that are disposed opposite to each other in the third direction Z. The first surface 105 is formed of the surface of the outermost first straight portion 101 above the winding center M, the surface of the outermost first bend portion 102 above the winding center M, and the surface of the outermost second bend portion 104 above the winding center M. The second surface 106 is formed of the surface of the outermost first straight portion 101 below the winding center M, the surface of the outermost first bend portion 102 below the winding center M, and the surface of the outermost second bend portion 104 below the winding center M. A first boundary 11A between the outermost first straight portion 101 and the outermost first bend portion 102 of the electrode assembly 10 is an intersection between a dashed line AA and the first surface 105, the dashed line AA is formed by extending a bent edge in the third direction Z, and the bent edge is located on the innermost side of the electrode assembly 10 and located on a side (left side in FIG. 3) of the winding center M in the first direction X. A second boundary 11B between the outermost second straight portion 103 and the outermost first bend portion 102 of the electrode assembly 10 is an intersection between a dashed line AA and the second surface 106, the dashed line AA is formed by extending a bent edge in the third direction Z, and the bent edge is located on the innermost side of the electrode assembly 10 and located on a side (left side in FIG. 3) of the winding center M in the first direction X. A third boundary 11C between the outermost first straight portion 101 and the outermost second bend portion 104 of the electrode assembly 10 is an intersection between a dashed line BB and the first surface 105, the dashed line BB is formed by extending a bent edge in the third direction Z, and the bent edge is located on the innermost side of the electrode assembly 10 and located on a side (right side in FIG. 3) of the winding center M in the first direction X. A fourth boundary 11D between the outermost second straight portion 103 and the outermost second bend portion 104 of the electrode assembly 10 is an intersection between a dashed line BB and the second surface 106, the dashed line BB is formed by extending a bent edge in the third direction Z, and the bent edge is located on the innermost side of the electrode assembly 10 and located on a side (right side in FIG. 3) of the winding center M in the first direction X. The first boundary 11A between the outermost first straight portion 101 and the outermost first bend portion 102 of the electrode assembly 10, the second boundary 11B between the outermost second straight portion 103 and the outermost first bend portion 102 of the electrode assembly 10, the third boundary 11C between the outermost first straight portion 101 and the outermost second bend portion 104 of the electrode assembly 10, and the fourth boundary 11D between the outermost second straight portion 103 and the outermost second bend portion 102 of the electrode assembly 10 are located at four corner positions of the electrode assembly 10 respectively. FIG. 3 shows a corner position B-B of the electrode assembly 10. Referring to FIG. 1 and FIG. 3, the corner position B-B of the electrode assembly 10 is opposite to a corner position A-A of the housing 20.

In the winding direction W of the electrode assembly 10, the first layer 11 includes a starting end 11a and an ending end 11b disposed opposite to each other. The positive electrode plate 12 includes a starting end 12a and an ending end 12b disposed opposite to each other. The negative electrode plate 13 includes a starting end 13a and an ending end 13b disposed opposite to each other. In this application, the winding direction W means a direction of winding around the second direction Y The starting end means an end of the first layer 11, the positive electrode plate 12, or the negative electrode plate 13 at a winding initiation position in the winding direction W. The ending end means an end of the first layer 11, the positive electrode plate 12, or the negative electrode plate 13 at a winding termination position in the winding direction W. In this embodiment, the ending end 11b of the first layer 11 and the ending end 13b of the negative electrode plate 13 are located in the first bend portion 102, and the ending end 12b of the positive electrode plate 12 is located in the first straight portion 101. By disposing the ending end 13b of the negative electrode plate 13 in the first bend portion 102, this application enables the corner at the ending end 13b of the negative electrode plate 13 to be away from the corner position A-A of the housing 20, thereby reducing the risk that the corner of the ending end 13b of the negative electrode plate 13 pierces the second layer of the housing, and in turn, reducing the risk that the first metal layer 22 of the housing 20 is in contact with the electrolyte solution or the negative electrode plate 13, reducing the risk of corrosion caused by the reaction between the first metal layer 22 and the electrolyte solution or reducing the risk of corrosion caused by the contact between the first metal layer 22 and the negative electrode plate 13 infiltrated by the electrolyte solution due to a difference in the potential, and increasing the lifespan of the housing 20.

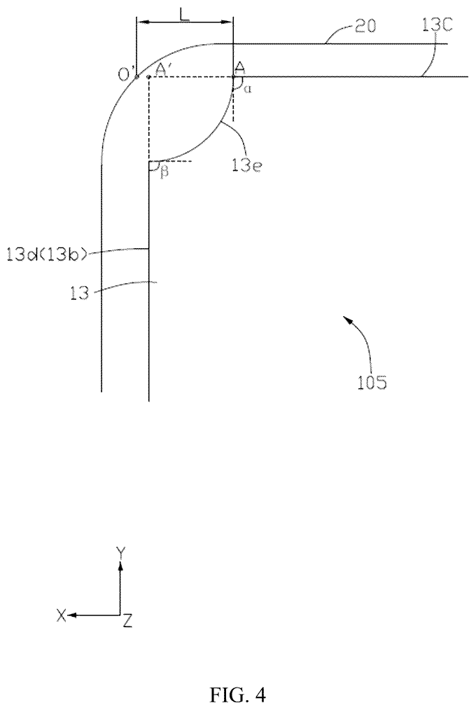

Referring to FIG. 4, in FIG. 4, the first layer is omitted, and the negative electrode plate 13 is located on the outermost layer of the electrode assembly 10. The negative electrode plate 13 includes a first edge 13c extending along the first direction X and a second edge 13d extending along the second direction Y The first edge 13c is connected to the second edge 13d by the third edge 13e. The first edge 13c intersects the third edge 13e to form a first intersection point A. The second edge 13d is also the ending end 13b of the negative electrode plate 13, and the third edge 13e is located at a corner position of the ending end 13b of the negative electrode plate 13. The angle α formed at the junction between the third edge 13e and the first edge 13c as well as the angle β formed at the junction between the third edge 13e and the second edge 13d are both acute angles. In this embodiment, the third edge 13e is a concave curve.

Referring to FIG. 1 and FIG. 4, the housing 20 further includes a first wall 201, a second wall 202, and a third wall 203 that are connected to each other. The first wall 201 is perpendicular to the third direction Z, the second wall 202 is perpendicular to the second direction Y, and the third wall 203 is perpendicular to the first direction X. The first wall 201 is connected to the second wall 202 by a first arc wall 211. The first wall 201 is connected to the third wall 203 by a second arc wall 212. The second wall 202 is connected to the third wall 203 by a third arc wall 213. The arc radius of the first arc wall 211 is R₁, and the arc radius of the second arc wall 212 is R₂. A midpoint connection line L1 that connects midpoints of all arc edges on the first arc wall 211, a midpoint connection line L₂ that connects midpoints of all arc edges on the second arc wall 212, and a midpoint connection line L₃ that connects midpoints of all arc edges on the third arc wall 213 intersect at a second intersection point O. The second intersection point O is a spherical face center of the corner position A-A of the housing 20, and is located at a relatively thin position on the first metal layer 22 in the housing 20. The negative electrode plate 13 includes a part containing the first intersection point A, and a projection of the second intersection point O on the first surface 105 or the second surface 106 of the electrode assembly 10 on which the part is located is a third intersection point O′. In some embodiments, the part containing the first intersection point A on the negative electrode plate 13 means a part from the ending end 13b of the negative electrode plate to the first intersection point A on the negative electrode plate 13, and may be located on the first surface 105 and/or the second surface 106. In some embodiments, the third intersection point O′ means a projection of the second intersection point O on the first surface 105 or the second surface 106, whichever is closer to the first intersection point A. A distance L between the third intersection point O′ and the first intersection point A satisfies a relational expression L≥0.8(R₁+R₂).

The extension line of the first edge 13c and the extension line of the second edge 13d intersect to form a virtual intersection point A′. The virtual intersection point A′ is opposite to the corner position of the housing 20. By disposing the third edge 13e, this application enables the junction between the third edge 13e and the first edge 13c as well as the junction between the third edge and the second edge 13d to be away from the corner position of the housing 20, and enables the distance L between the third intersection point O′ and the first intersection point A to satisfy the relational expression L≥0.8(R₁+R₂), thereby reducing the risk that the negative electrode plate 13 pierces the second layer 21 of the housing 20, and in turn, reducing the risk that the first metal layer 22 of the housing 20 is in contact with the electrolyte solution or the negative electrode plate 13, reducing the risk of corrosion caused by the reaction between the first metal layer 22 and the electrolyte solution or reducing the risk of corrosion caused by the contact between the first metal layer 22 and the negative electrode plate 13 infiltrated by the electrolyte solution due to a difference in the potential, and increasing the lifespan of the housing 20. In addition, by disposing the third edge 13e, a notch structure is formed at the corner position of the negative electrode plate 13. The notch structure can be used as a cutting mark in a process of preparing a negative electrode plate from a negative electrode plate web, thereby reducing the risk of defective products (for example, tab dislocation) due to an incorrect cutting position.

Referring to FIG. 3, the negative electrode plate 13 includes a second metal layer 131, a first conductive material layer 132, and a second conductive material layer 133. The second metal layer 131 includes a first face 131a and a second face 131b disposed opposite to each other. Along the winding direction W, the first conductive material layer 132 is disposed continuously on the first face 131a, and the second conductive material layer 133 is disposed continuously on the second face 131b. During manufacturing, the conductive material may be applied continuously on the first face 131a and the second face 131b of the second metal layer 131 to improve the manufacturing efficiency. Both the first conductive material layer 132 and the second conductive material layer 133 function as active layers, and may be at least one selected from a graphite material, an alloy material, lithium metal, or an alloy thereof. The graphite material may be at least one selected from artificial graphite or natural graphite. The alloy material may be at least one selected from silicon, silicon oxide, tin, or titanium sulfide. The second metal layer 131 serves a function of collecting current, and may include at least one of Ni, Ti, Cu, Ag, Au, Pt, Fe, Co, Cr, W, Mo, Al, Mg, K, Na, Ca, Sr, Ba, Si, Ge, Sb, Pb, In, Zn, or a combination thereof. In this embodiment, the second metal layer 131 includes copper.

The positive electrode plate 12 includes a third metal layer 121, a third conductive material layer 122, and a fourth conductive material layer 123. The third metal layer 121 includes a third face 121a and a fourth face 121b disposed opposite to each other. Along the winding direction W, the third conductive material layer 122 is disposed continuously on the third face 121a, and the fourth conductive material layer 123 is disposed continuously on the fourth face 121b. During manufacturing, the conductive material may be applied continuously on the third face 121a and the fourth face 121b of the third metal layer 121 to improve the manufacturing efficiency. The third conductive material layer 122 and the fourth conductive material layer 123 both play a role of an active layer, and each may include at least one of lithium cobalt oxide, lithium manganese oxide, lithium nickel oxide, lithium nickel cobalt manganese oxide, lithium iron phosphate, lithium manganese iron phosphate, lithium vanadium phosphate, lithium vanadyl phosphate, a lithium-rich manganese-based material, a lithium nickel cobalt aluminum oxide, or a combination thereof. The third metal layer 121 serves a function of collecting current, and may include at least one of Ni, Ti, Cu, Ag, Au, Pt, Fe, Co, Cr, W, Mo, Al, Mg, K, Na, Ca, Sr, Ba, Si, Ge, Sb, Pb, In, Zn, or a combination thereof.

The first layer 11 is configured to prevent direct contact between the positive electrode plate 12 and the negative electrode plate 13, thereby reducing the risk of a short circuit caused by contact between the first conductive layer 111 and the second conductive layer 112. The first layer 11 includes an insulation material. The insulation material may be at least one selected from polypropylene, polyethylene, polyvinylidene difluoride, poly(vinylidene fluoride-co-hexafluoropropylene), polymethyl methacrylate, or polyethylene glycol. The first layer 11 may be a separator.

In some embodiments, the material of the first layer 11 is polyethylene, and the thickness of the first layer 11 ranges from 14 μm to 25 μm. In some other embodiments, the material of the first layer 11 is polypropylene, and the thickness of the first layer 11 ranges from 5 μm to 12 μm. The thicker the first layer 11, the more the first layer helps to alleviate corrosion, and the less intensely the distance L between the third intersection point O′ and the first intersection point A deteriorates corrosion.

In some embodiments, the electrode assembly 10 further includes a third layer 30. The third layer 30 is connected to the first layer 11 and located in the first bend portion 102. The third layer 30 is configured to connect the first layer 11 to the second layer of the housing, so as to fix the electrode assembly 10 onto the housing. The third layer 30 includes an insulation material. The insulation material may include at least one of acrylate, polyurethane, rubber, or silicone. In other embodiments, the third layer 30 may be located in the first straight portion 101 or the second bend portion 104.

In some embodiments, a surface of the first layer 11 is covered with a coating 40. The coating 40 may be an inorganic coating or an organic coating. The inorganic coating may include inorganic particles and a binder. The inorganic particles may be at least one of aluminum trioxide, silicon dioxide, titanium dioxide, zirconium dioxide, cerium dioxide, calcium oxide, calcium carbonate, or barium titanate. The binder may be at least one of poly(styrene-co-butadiene), polyvinylidene fluoride, polyvinylpyrrolidone, poly(vinylidene fluoride-co-hexafluoropropylene), polyacrylonitrile, sodium carboxymethyl cellulose, poly(butadiene-co-acrylonitrile), polyacrylic acid, polymethyl acrylate, polyethyl acrylate, or poly(acrylic acid-co-styrene). The organic coating may be at least one of polyvinylidene fluoride, polyvinylpyrrolidone, poly(vinylidene fluoride-co-hexafluoropropylene), polyacrylonitrile, sodium carboxymethyl cellulose, polyacrylic acid sodium, poly(butadiene-co-acrylonitrile), ethyl acetate, polyacrylic acid, polymethyl acrylate, polyethyl acrylate, or poly(acrylic acid-co-styrene). By applying the coating 40, the safety performance and mechanical performance of the first layer 11 can be improved, and corrosion is alleviated.

In some embodiments, the number of layers of the coating 40 on the surface of the first layer 11 is one or two. The larger the number of layers of the coating 40, the less intensely the distance L between the third intersection point O′ and the first intersection point A deteriorates corrosion.

In some embodiments, the thickness of the housing ranges from 80 μm to 150 μm. The thicker the housing, the more the housing helps to alleviate corrosion, and the less intensely the distance L between the third intersection point O′ and the first intersection point A deteriorates corrosion.

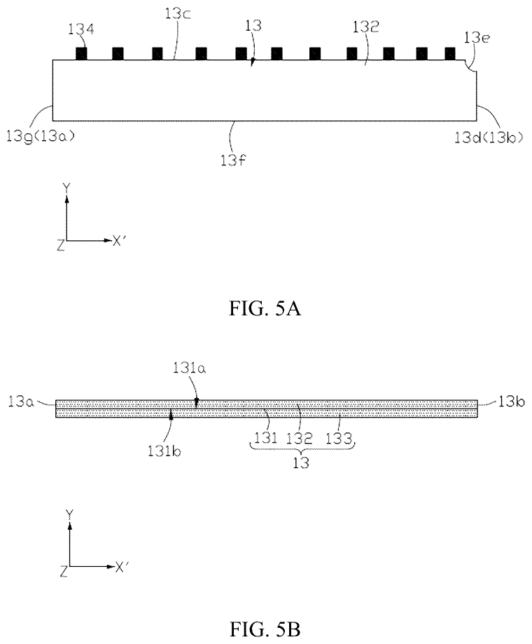

Referring to FIG. 5A and FIG. 5B, the negative electrode plate 13 further includes a fourth edge 13f and a fifth edge 13g. The fourth edge 13f is parallel to the first edge 13c, and the fifth edge 13g is parallel to the second edge 13d. The fifth edge 13g is vertically connected to both the first edge 13c and the fourth edge 13f. The second edge 13d is vertically connected to the fourth edge 13f. The fifth edge 13g serves as a starting end 13a of the negative electrode plate 13. In other embodiments, the first edge 13c may be vertically connected to the second edge 13d, and the second edge 13d may be connected to the fourth edge 13f by the third edge 13e. The first conductive material layer 132 is disposed on the first face 131a of the second metal layer 131, and is disposed continuously from the starting end 13a to the ending end 13b in a fourth direction X′. The second conductive material layer 133 is disposed on the second face 131b of the second metal layer 131, and is disposed continuously from the starting end 13a to the ending end 13b in the fourth direction X′. In this application, the fourth direction X is perpendicular to the second direction Y and the third direction Z, and is an extension direction of the negative electrode plate 13 before winding.

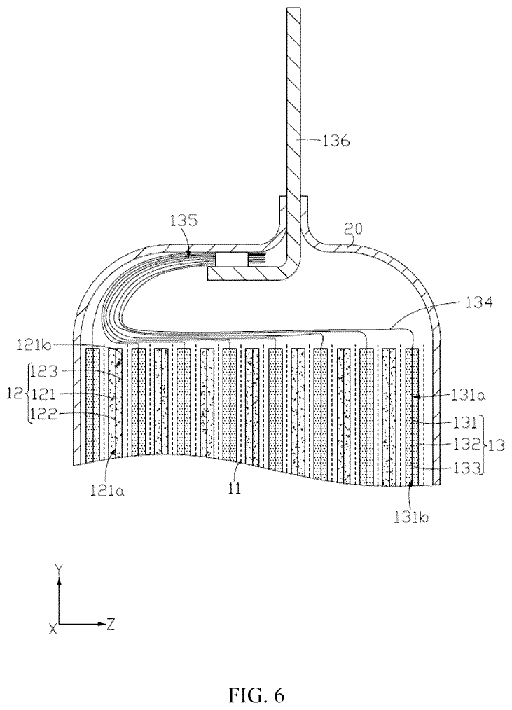

Referring to FIG. 5A, FIG. 5B, and FIG. 6, the negative electrode plate 13 further includes a plurality of negative tabs 134 and a first current collecting plate 136. The plurality of negative tabs 134 are formed by extending the electrode plate from one side of the second metal layer 131 and protrude beyond the first edge 13c of the negative electrode plate 13. In the fourth direction X′, the plurality of negative tabs 134 are spaced out. The plurality of negative tabs 134 are bent inside the housing 20 to form a first tab group 135. In this embodiment, the plurality of negative tabs 134 are formed by cutting the edge of the second metal layer 131. The first tab group 135 is connected to the first current collecting plate 136. The first tab group 135 may be connected to the first current collecting plate 136 by means such as welding but not limited to welding. An end, away from the first tab group 135, of the first current collecting plate 136, protrudes out of the housing 20, so as to connect to an external component. The first current collecting plate 136 may include at least one of Ni, Ti, Cu, Ag, Au, Pt, Fe, Co, Cr, W, Mo, Al, Mg, K, Na, Ca, Sr, Ba, Si, Ge, Sb, Pb, In, Zn, or a combination thereof.

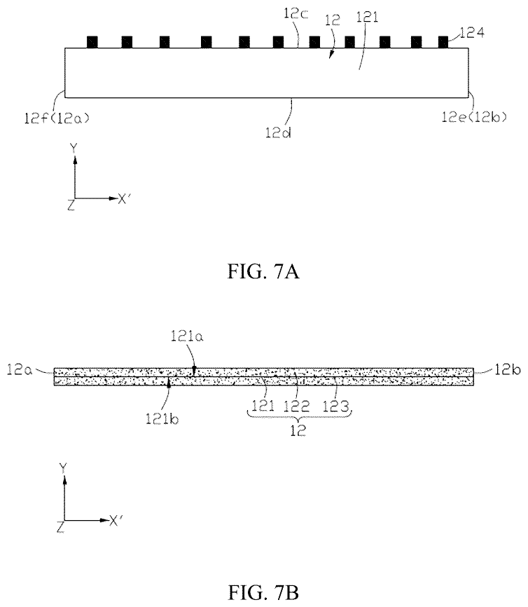

Referring to FIG. 7A and FIG. 7B, the positive electrode plate 12 includes a sixth edge 12c and a seventh edge 12d extending along the fourth direction X′ and parallel to each other, and an eighth edge 12e and a ninth edge 12f extending along the second direction Y and parallel to each other. The eighth edge 12e serves as an ending end 12b of the positive electrode plate 12. The ninth edge 12f serves as a starting end 12a of the positive electrode plate 12. The sixth edge 12c is vertically connected to both the eighth edge 12e and the ninth edge 12f. The seventh edge 12d is vertically connected to both the eighth edge 12e and the ninth edge 12f. The third conductive material layer 122 is disposed on the third face 121a of the third metal layer 121, and is disposed continuously from the starting end 12a to the ending end 12b in the fourth direction X′. The fourth conductive material layer 123 is disposed on the fourth face 121b of the third metal layer 121, and is disposed continuously from the starting end 12a to the ending end 12b in the fourth direction X′.

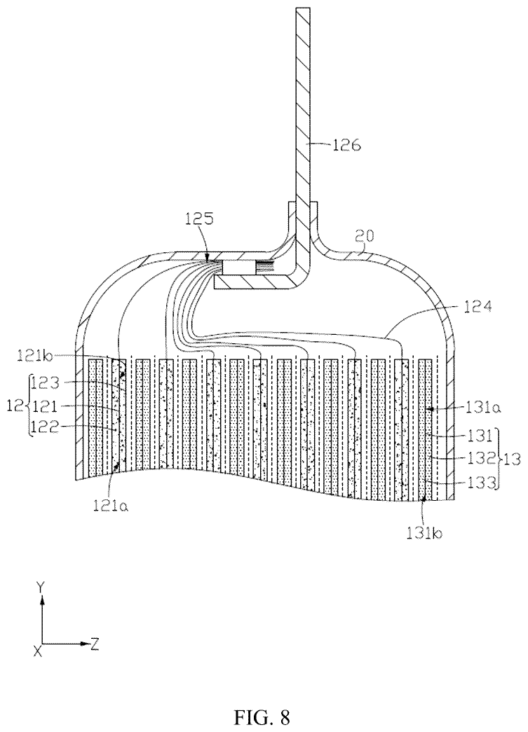

Referring to FIG. 7A, FIG. 7B, and FIG. 8, the positive electrode plate 12 further includes a plurality of positive tabs 124 and a second current collecting plate 126. The plurality of positive tabs 124 are formed by extending the electrode plate from one side of the third metal layer 121 and protrude beyond the sixth edge 12c. In the fourth direction X′, the plurality of positive tabs 124 are spaced out. The plurality of positive tabs 124 are bent inside the housing to form a second tab group 125. In this embodiment, the plurality of positive tabs 124 are formed by cutting the edge of the third metal layer 121. The second tab group 125 is connected to the second current collecting plate 126. The second tab group 125 may be connected to the second current collecting plate 126 by means such as welding but not limited to welding. An end, away from the second tab group 125, of the second current collecting plate 126, protrudes out of the housing 20, so as to connect to an external component. The second current collecting plate 126 may include at least one of Ni, Ti, Cu, Ag, Au, Pt, Fe, Co, Cr, W, Mo, Al, Mg, K, Na, Ca, Sr, Ba, Si, Ge, Sb, Pb, In, Zn, or a combination thereof.

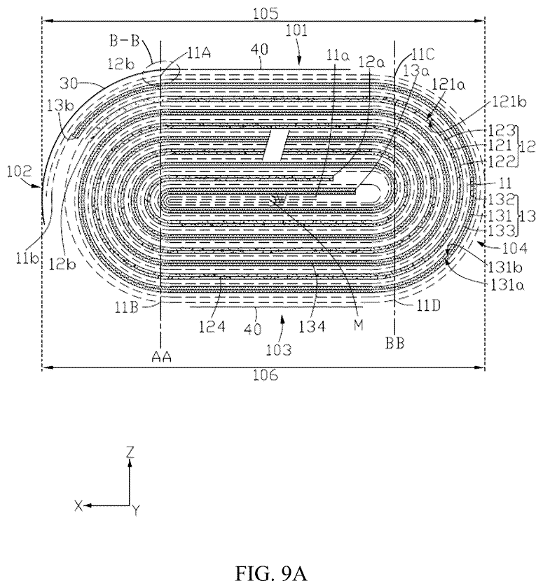

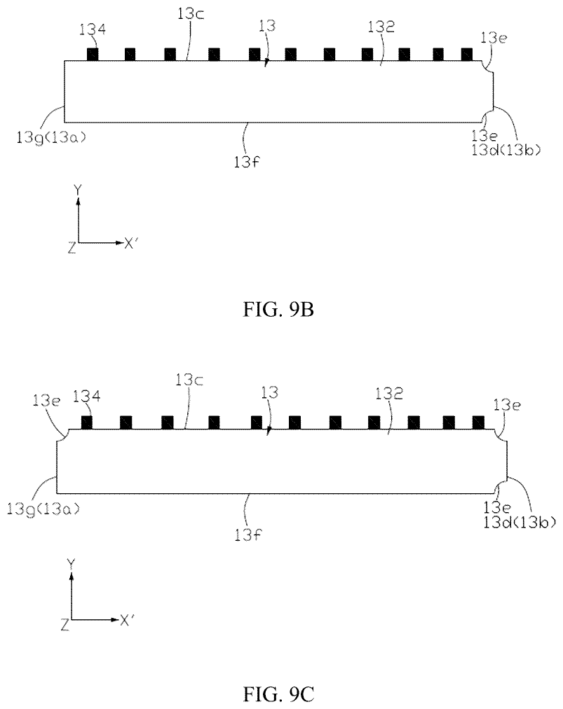

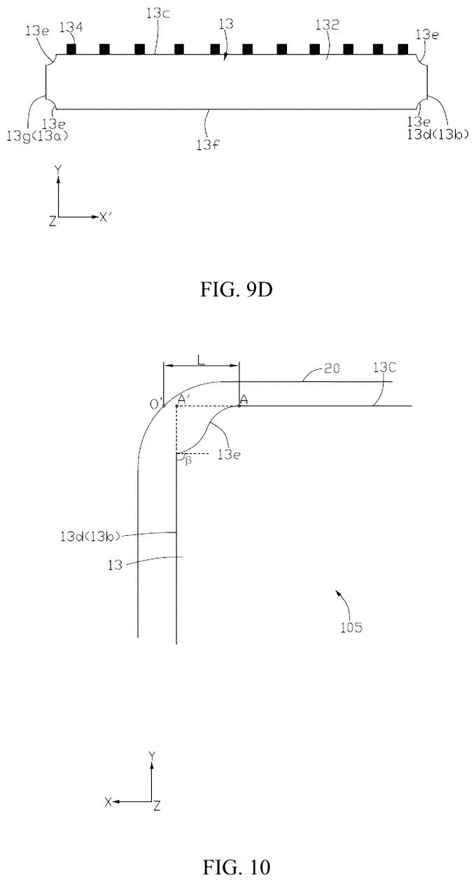

Referring to FIG. 9A, in some embodiments, the ending end 11b of the first layer 11, the ending end 13b of the negative electrode plate 13, and the ending end 12b of the positive electrode plate 12 are all located in the first bend portion 102. In some other embodiments, the ending end 11b of the first layer 11, the ending end 13b of the negative electrode plate 13, and the ending end 12b of the positive electrode plate 12 may be located in the first bend portion 102 and the second bend portion 104 separately, or may be all located in the second bend portion 104.

Referring to FIG. 9B, in some embodiments, the negative electrode plate 13 includes two third edges 13e. One of the third edges 13e is connected to the first edge 13c and the second edge 13d, and the other third edge 13e is connected to the second edge 13d and the fourth edge 13f By disposing two third edges 13e, a notch structure is formed at both corner positions at the ending end 13b of the negative electrode plate 13.

Referring to FIG. 9C, in some embodiments, the negative electrode plate 13 includes three third edges 13e. One of the third edges 13e is connected to the first edge 13c and the second edge 13d, another third edge 13e is connected to the second edge 13d and the fourth edge 13f, and another third edge 13e is connected to the first edge 13c and the fifth edge 13g. By disposing three third edges 13e, a notch structure is formed at both corner positions at the ending end 13b of the negative electrode plate 13 as well as one corner position at the starting end 13a of the negative electrode plate 13.

Referring to FIG. 9D, in some embodiments, the negative electrode plate 13 includes four third edges 13e. One of the third edges 13e is connected to the first edge 13c and the second edge 13d, one third edge 13e is connected to the second edge 13d and the fourth edge 13f, one third edge 13e is connected to the first edge 13c and the fifth edge 13g, and another third edge 13e is connected to the fifth edge 13g and the fourth edge 13f. By disposing four third edges 13e, a notch structure is formed at both corner positions at the ending end 13b of the negative electrode plate 13 as well as both corner positions at the starting end 13a of the negative electrode plate 13.

Referring to FIG. 10, in some embodiments, the third edge 13e is a curve formed by a concave curve and a convex curve. The junction between the third edge 13e and the first edge 13c is an arc-shaped transition, and the angle β formed at the junction between the third edge 13e and the second edge 13d is an acute angle. Of the two third edges 13e, one forms two angles (acute angles) to the first edge 13c and the second edge 13d respectively, and the other forms two angles (acute angles) to the fourth edge 13f and the second edge 13d respectively. In some other embodiments, the junction between the third edge 13e and the second edge 13d may be an arc-shaped transition, and the angle α formed at the junction between the third edge 13e and the first edge 13c may be an acute angle.

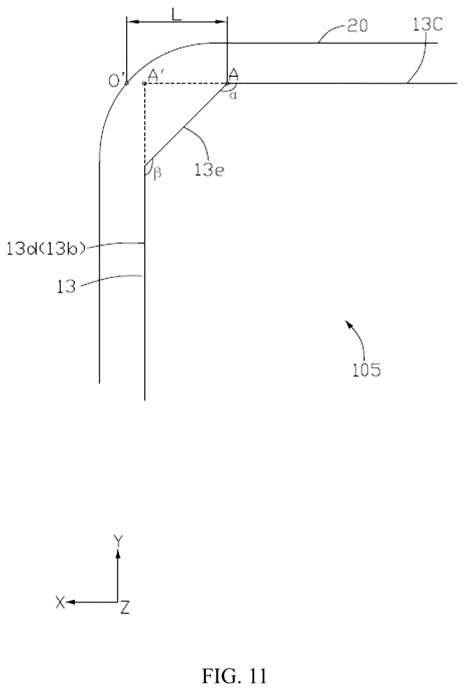

Referring to FIG. 11, in some embodiments, the third edge 13e is a straight line. The angle α formed at the junction between the third edge 13e and the first edge 13c is an obtuse angle, and the angle β formed at the junction between the third edge 13e and the second edge 13d is an acute angle. Of the two third edges 13e, one forms two angles to the first edge 13c and the second edge 13d respectively, and the other forms two angles to the fourth edge 13f and the second edge 13d respectively. Of the four angles formed, two are obtuse angles, and two are acute angles. In some embodiments, the range of the obtuse angles is greater than 900 and less than or equal to 150°. In some other embodiments, the third edge 13e may be a line segment formed by a straight line segment and another straight line segment, or formed by a straight line segment and a curve segment. The angle α formed at the junction between the third edge 13e and the first edge 13c may be an acute angle, and the angle β formed at the junction between the third edge 13e and the second edge 13d may be an obtuse angle.

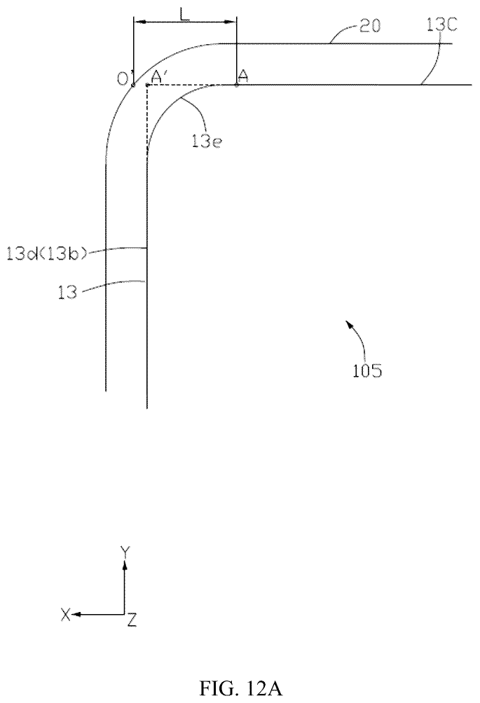

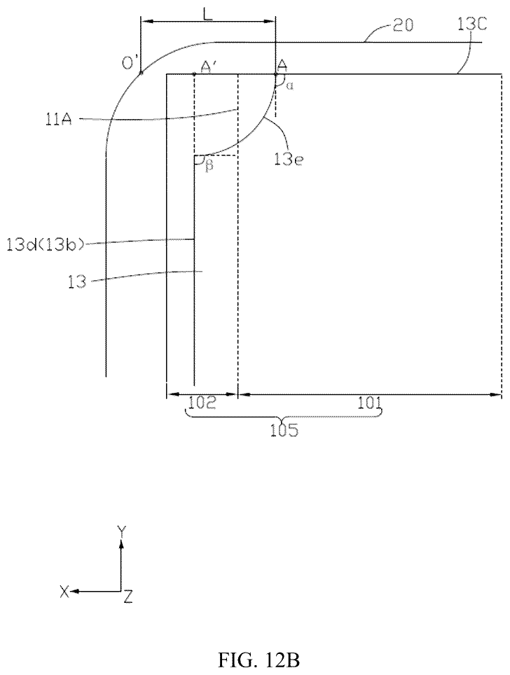

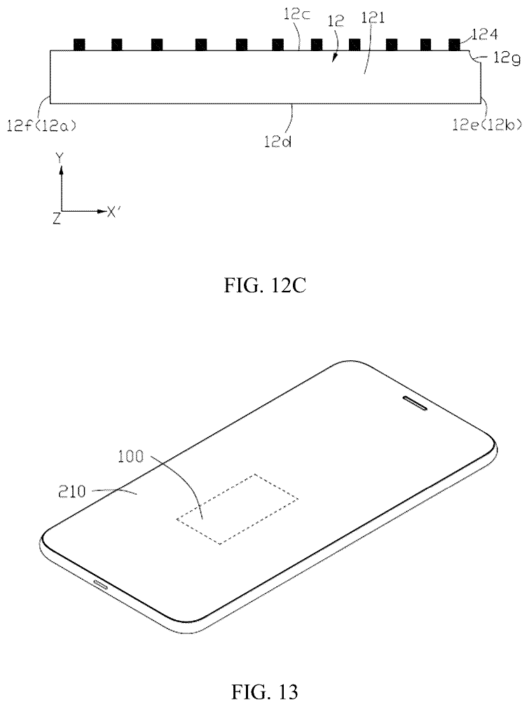

Referring to FIG. 12A, in some embodiments, the third edge 13e is an arc line. Both the junction between the third edge 13e and the first edge 13c and the junction between the third edge 13e and the second edge 13d are arc-shaped transitions. When the junction between the third edge 13e and the first edge 13c as well as the junction between the third edge and the second edge 13d are both arc-shaped transitions, the corrosion is alleviated even if the distance L between the third intersection point O′ and the first intersection point A does not satisfy the relational expression L≥0.8(R₁+R₂).

Referring to FIG. 12B, in some embodiments, the first edge 13c intersects the third edge 13e to form a first intersection point A, and the first intersection point A is located in the first straight portion 101. Specifically, the ending end 13b of the negative electrode plate 13 is located in the first bend portion 102. The third edge 13e extends from the first bend portion 102 to the first straight portion 101. In other embodiments, both the ending end 13b of the negative electrode plate 13 and the first intersection point A may be located in the first straight portion 101.

Referring to FIG. 12C, in some embodiments, the positive electrode plate 12 further includes a tenth edge 12g. The sixth edge 12c may be connected to the seventh edge 12d by the tenth edge 12g. The tenth edge 12g includes at least one of a straight line segment or a curved line segment. The tenth edge 12g is caused to form a notch structure at the corner position of the positive electrode plate 12, and the notch structure can be used as a cutting mark in a process of manufacturing the positive electrode plate. In some other embodiments, the positive electrode plate 12 may include a plurality of tenth edges 12g. The sixth edge 12c and the seventh edge 12d may be connected to the eighth edge 12e and the ninth edge 12f respectively by the tenth edge 12g, thereby forming a notch structure at each corner position of the positive electrode plate 12.

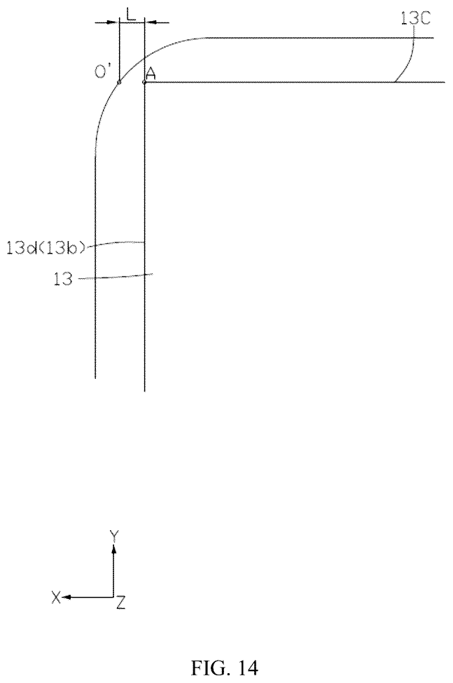

Referring to FIG. 13, an embodiment of this application further provides an electronic device 200. The electronic device 200 includes a main body 220 and a battery 100. The battery 100 is accommodated in the main body 220. The electronic device 200 may be one of a mobile phone, a tablet computer, or an electronic reader.

Using a mobile phone as an example of the electronic device 200 in this application, the battery 100 is disposed in the mobile phone to provide electrical energy to the mobile phone. The main body 220 is a mobile phone structure. Understandably, in other embodiments, the electronic device 200 may be other structures, without being limited to the mobile phone, tablet computer, and electronic reader.

This application forms a notch structure by disposing a third edge at a corner position of the ending end of the negative electrode plate. In this way, the angle (obtuse angle or acute angle) located at the ending end of the negative electrode plate is far away from the corner position of the housing. In addition, the projection of a spherical face center at the corner position of the housing on the first surface or the second surface of the electrode assembly on which the ending end of the negative electrode plate is located forms a third intersection point O′. The third intersection point and the first intersection point A located at the corner of the ending end of the negative electrode plate satisfy the relational expression L≥0.8(R₁+R₂), thereby reducing the risk of the negative electrode plate piercing the second layer of the housing, and in turn, reducing the risk of contact between the first metal layer of the housing and the negative electrode plate or an electrolyte solution, alleviating corrosion, and increasing the lifespan of the housing. In addition, the notch structure formed at the corner position at the ending end of the negative electrode plate may be used as a cutting mark, thereby facilitating identification and positioning during the cutting, and facilitating division of a negative electrode plate web into a plurality of negative electrode plates available for use in finished batteries during manufacturing.

The following describes the performance of the battery according to this application with reference to specific embodiments and comparative embodiments.

### Embodiment 1

Putting an electrode assembly into a housing, and performing electrolyte injection, packaging, and chemical formation to obtain a finished battery shown in FIG. 10. The distance L between the third intersection point O′ and the first intersection point A satisfies a relational expression L=0.8(R₁+R₂).

### Embodiment 2

Putting an electrode assembly into a housing, and performing electrolyte injection, packaging, and chemical formation to obtain a finished battery shown in FIG. 10. The distance L between the third intersection point O′ and the first intersection point A satisfies a relational expression L=1.0(R₁+R₂).

### Embodiment 3

Putting an electrode assembly into a housing, and performing electrolyte injection, packaging, and chemical formation to obtain a finished battery shown in FIG. 11. The distance L between the third intersection point O′ and the first intersection point A satisfies a relational expression L=1.0(R₁+R₂).

### Comparative Embodiment 1

Putting an electrode assembly into a housing, and performing electrolyte injection, packaging, and chemical formation to obtain a finished battery shown in FIG. 14. The battery 100 shown in FIG. 14 differs from the battery 100 shown in FIG. 4 in that the first edge 13c directly intersects the second edge 13d to form a first intersection point A. The first edge 13c and the fourth edge are vertically connected to the second edge 13d separately. That is, two right angles are formed at two corner positions of the second edge 13d. The distance L between the third intersection point O′ and the first intersection point A satisfies a relational expression L=0.4(R₁+R₂).

### Comparative Embodiment 2

Putting an electrode assembly into a housing, and performing electrolyte injection, packaging, and chemical formation to obtain a finished battery shown in FIG. 10. The distance L between the third intersection point O′ and the first intersection point A satisfies a relational expression L=0.6(R₁+R₂).

### Comparative Embodiment 3

Putting an electrode assembly into a housing, and performing electrolyte injection, packaging, and chemical formation to obtain a finished battery shown in FIG. 11. The distance L between the third intersection point O′ and the first intersection point A satisfies a relational expression L=0.6(R₁+R₂).

Taking 1000 specimens of batteries prepared in each embodiment and each comparative embodiment to perform a corrosion test. The test results are shown in Table 1 below.

Corrosion test: Measuring a voltage difference between the first current collecting plate and the first metal layer of the battery specimens. When the voltage difference is greater than or equal to 0.6 V, the probability of corrosion is high, and it is determined that the specimen fails the corrosion test. When the voltage difference is less than 0.6 V, it is determined that the specimen passes the corrosion test.

TABLE 1

| | Number of | | |
|---|---|---|---|
| | angles | Relational expression | Corrosion status |
| Embodiment 1 | 2 | L = 0.8(R₁ + R₂) | 0/1000 |
| Embodiment 2 | 2 | L = 1.0(R₁ + R₂) | 0/1000 |
| Embodiment 3 | 4 | L = 1.0(R₁ + R₂) | 0/1000 |
| Comparative | 2 | L = 0.4(R₁ + R₂) | 150/1000 |
| Embodiment 1 | | | |
| Comparative | 2 | L = 0.6(R₁ + R₂) | 60/1000 |
| Embodiment 2 | | | |
| Comparative | 4 | L = 0.6(R₁ + R₂) | 90/1000 |
| Embodiment 3 | | | |

Note:
X/1000 means that the number of specimens that fail the corrosion test among 1000 specimens is X.

As can be seen from the test results in Table 1, in Embodiments 1 to 3 versus Comparative Embodiments 1 to 3, corrosion can be alleviated by disposing the third edge and making the third intersection point O′ and the first intersection point A satisfy the relational expression L≥0.8(R₁+R₂).

What is disclosed above is merely exemplary embodiments of this application, and in no way constitutes a limitation on this application. Therefore, any and all equivalent variations made based on this application still fall within the scope covered by this application.

What is claimed is:

1. A battery comprising:
an electrode assembly comprising electrode plates and a first layer containing an insulation material, wherein the electrode plates comprise a positive electrode plate and a negative electrode plate, the first layer is disposed between the positive electrode plate and the negative electrode plate, the negative electrode plate is located on an outermost layer of the electrode plates, the negative electrode plate comprises a first edge extending along a first direction and a second edge extending along a second direction, the first direction is perpendicular to the second direction, the first edge is connected to the second edge by a third edge, and the first edge intersects the third edge to form a first intersection point; and
a housing accommodating the electrode assembly, wherein the housing comprises a first metal layer and a second layer containing a polymer material, the first metal layer and the second layer are stacked together, and the second layer is disposed closer to the electrode assembly than the first metal layer;
wherein the housing further comprises a first wall, a second wall, and a third wall that are connected to each other; the first wall is connected to the second wall by a first arc wall; the first wall is connected to the third wall by a second arc wall; the second wall is connected to the third wall by a third arc wall; an arc radius of the first arc wall is R₁; an arc radius of the second arc wall is R₂; a midpoint connection line of the first arc wall, a midpoint connection line of the second arc wall, and a midpoint connection line of the third arc wall intersect to form a second intersection point; the electrode assembly further comprises a first surface and a second surface disposed opposite to each other in a third direction; the third direction is perpendicular to the first direction and the second direction; the negative electrode plate comprises a part containing the first intersection point, and an orthogonal projection of the second intersection point on the first surface or the second surface of the electrode assembly on which the part is located is a third intersection point; and a distance L between the third intersection point and the first intersection point satisfies L≥0.8(R₁+R₂).

2. The battery according to claim 1, wherein both a junction between the third edge and the first edge, and a junction between the third edge and the second edge, are arc-shaped transition connections.

3. The battery according to claim 1, wherein an angle formed at a junction between the third edge and the first edge is a first obtuse angle or a first acute angle, and an angle formed at a junction between the third edge and the second edge is a second obtuse angle or a second acute angle.

4. The battery according to claim 1, wherein one of a junction between the third edge and the first edge or a junction between the third edge and the second edge is an arc-shaped transition connection, and an angle formed at the other one of the junction between the third edge and the first edge or the junction between the third edge and the second edge is an obtuse angle or an acute angle.

5. The battery according to claim 1, wherein the third edge comprises at least one of a curve or a straight line.

6. The battery according to claim 1, wherein the negative electrode plate, the first layer, and the positive electrode plate are stacked and then wound to form the electrode assembly; the electrode assembly further comprises a first bend portion, a second bend portion, a first straight portion and a second straight portion; the first straight portion and the second straight portion are disposed opposite to each other in the third direction, and the first bend portion and the second bend portion are connected between the first straight portion and the second straight portion and disposed opposite to each other in the first direction.

7. The battery according to claim 6, wherein in a winding direction, the second edge is an ending end of the negative electrode plate.

8. The battery according to claim 6, wherein an ending end of the negative electrode plate is located in the first bend portion.

9. The battery according to claim 6, wherein an ending end of the positive electrode plate is located in the first bend portion.

10. The battery according to claim 6, wherein an ending end of the first layer is located in the first bend portion.

11. The battery according to claim 6, wherein the first intersection point is located in the first straight portion.

12. The battery according to claim 6, wherein the first layer is located on an outermost layer of the electrode assembly, the electrode assembly further comprises a third layer containing an insulation material, and the third layer is connected to the first layer and located in the first bend portion.

13. The battery according to claim 11, wherein a surface of the first layer is covered with a coating.

14. The battery according to claim 1, wherein the negative electrode plate comprises a second metal layer, a first conductive material layer, and a second conductive material layer; the second metal layer comprises a first face and a second face disposed opposite to each other; the negative electrode plate further comprises a starting end and an ending end disposed opposite to each other in a winding direction of the electrode assembly; the first conductive material layer is disposed continuously on the first face from the starting end of the negative electrode plate to the ending end of the negative electrode plate; and the second conductive material layer is disposed continuously on the second face from the starting end of the negative electrode plate to the ending end of the negative electrode plate.

15. The battery according to claim 14, wherein the negative electrode plate further comprises a plurality of negative tabs formed by extending the electrode plate from one side of the second metal layer.

16. The battery according to claim 15, wherein the negative electrode plate further comprises a first current collecting plate, the plurality of negative tabs are bent in the housing to form a first tab group, the first tab group is connected to the first current collecting plate; and an end of the first current collecting plate protrudes out of the housing, the end of the first current plate is an facing away from the tab group.

17. The battery according to claim 14, wherein the second metal layer comprises copper.

18. The battery according to claim 1, wherein the positive electrode plate comprises a third metal layer, a third conductive material layer, and a fourth conductive material layer; the third metal layer comprises a third face and a fourth face disposed opposite to each other; the positive electrode plate further comprises a starting end and an ending end disposed opposite to each other in a winding direction of the electrode assembly; the third conductive material layer is disposed continuously on the third face from the starting end of the positive electrode plate to the ending end of the positive electrode plate; and the fourth conductive material layer is disposed continuously on the fourth face from the starting end of the positive electrode plate to the ending end of the positive electrode plate.

19. The battery according to claim 18, wherein the positive electrode plate comprises a plurality of positive tabs formed by extending the electrode plate from one side of the third metal layer.

20. The battery according to claim 19, wherein the positive electrode plate further comprises a second current collecting plate, the plurality of positive tabs are bent in the housing to form a second tab group, the second tab group is connected to the second current collecting plate; and an end of the second current collecting plate protrudes out of the housing, the end of the second current collecting plate is an end facing away from the second tab group.

21. The battery according to claim 1, wherein a thickness of the housing ranges from 80 μm to 150 μm.

22. The battery according to claim 1, wherein the first metal layer comprises aluminum; and the polymer material comprises polyethylene, polypropylene, poly(ethylene-co-propylene), a modified polyethylene material, or a modified polypropylene material.

23. An electronic device comprising a battery; wherein the battery comprises:
an electrode assembly comprising electrode plates and a first layer containing an insulation material, wherein the electrode plates comprise a positive electrode plate and a negative electrode plate, the first layer is disposed between the positive electrode plate and the negative electrode plate, the negative electrode plate is located on an outermost layer of the electrode plates, the negative electrode plate comprises a first edge extending along a first direction and a second edge extending along a second direction, the first direction is perpendicular to the second direction, the first edge is connected to the second edge by a third edge, and the first edge intersects the third edge to form a first intersection point; and
a housing accommodating the electrode assembly, wherein the housing comprises a first metal layer and a second layer containing a polymer material, the first metal layer and the second layer are stacked together, and the second layer is disposed closer to the electrode assembly than the first metal layer;
wherein the housing further comprises a first wall, a second wall, and a third wall that are connected to each other; the first wall is connected to the second wall by a first arc wall; the first wall is connected to the third wall by a second arc wall; the second wall is connected to the third wall by a third arc wall; an arc radius of the first arc wall is R₁; an arc radius of the second arc wall is R₂; a midpoint connection line of the first arc wall, a midpoint connection line of the second arc wall, and a midpoint connection line of the third arc wall intersect to form a second intersection point; the electrode assembly further comprises a first surface and a second surface disposed opposite to each other in a third direction; the third direction is perpendicular to the first direction and the second direction; the negative electrode plate comprises a part containing the first intersection point, and an orthogonal projection of the second intersection point on the first surface or the second surface of the electrode assembly on which the part is located is a third intersection point; and a distance L between the third intersection point and the first intersection point satisfies L≥0.8(R₁+R₂).
